(19) United States
(12) Patent Application Publication
(10) Pub. No.: US 2012/0280001 A1
(43) Pub. Date: Nov. 8, 2012

(54) Venting Spout-Extending Attachment

(76) Inventor: Christopher William LEADBEATER, Marengo, OH (US)

(21) Appl. No.: 13/466,090

(22) Filed: May 7, 2012

Related U.S. Application Data
(60) Provisional application No. 61/483,589, filed on May 6, 2011.

(51) Int. Cl. B67D 3/00; B65D 35/38

(52) U.S. Cl. 222/481.5; 222/568

(57) ABSTRACT

A venting spout-extending attachment is an apparatus that is inserted and attached to the spout of a container with fluid. As the fluid is being poured out of the container, the apparatus relieves the vacuum pressure that is created by the outflow of the fluid. The apparatus has a dust-cap, a dust-cap attachment, a transfer tube, and a spout extender. The spout extender attaches the present invention to the spout of the container. The transfer tube is connected the spout extender opposite to the spout and is used to direct the outflow of fluid from the container. The dust-cap is used to prevent small particle from entering the container and the fluid through the present invention. The dust-attachment allows the dust-cap to attach to the opening of the transfer tube. The vent tube allows air to flow into the container to relieve the vacuum pressure.

The current application claims a priority to the U.S. Provisional Patent application Ser. No. 61/483,589 filed on May 6, 2012. The current application is filed on May 7, 2012 while May 6, 2012 was on a weekend.

### FIELD OF THE INVENTION

The present invention relates generally to an apparatus for a spout attachment. More particularly, the present invention attaches to pull-out spouts such as but not limited to Rieke spouts typically found on pal lids, plastic containers, and metal containers and provides a smooth release of contents stored therein.

### BACKGROUND OF THE INVENTION

When contents of various viscosities, particularly liquids which have a higher density than air, are stored within a container and then released by method of pouring, air pressure accumulates within the container, causing an irregular and unsteady outflow of the contents released or transferred. It is therefore an object of the present invention to introduce a spout attachment, particularly an extender, which relieves the pressure build-up accumulated within a container and allows for a smooth outflow of contents stored therein.

### BRIEF DESCRIPTION OF THE DRAWINGS

FIG. 1 is a close-up front-side view of a transfer tube applied to the ridged protrusion of a spout extender.

FIG. 2 is a close-up bottom-perspective view of the spout extender, demonstrating insertion of a vent tube.

FIG. 3 is a close-up view of an ideal offset distance of the vent tube from the transfer tube and the dust-cap attachment of the present invention.

FIG. 4 is a perspective view of the present invention, demonstrating the spout extender screwed onto a container and showing the vent tube's placement within the container.

FIG. 5 is a perspective view of a tilted container pouring the contents stored therein.

FIG. 6 is a bottom-side view of the spout extender of the present invention.

FIG. 7 is a side view of the spout extender of the present invention.

FIG. 8 is a top plan view of the spout extender of the present invention.

FIG. 9 is an isometric view of the spout extender of the present invention.

FIG. 10 is an exploded view of the present invention with associated parts.

### DETAILED DESCRIPTIONS OF THE INVENTION

All illustrations of the drawings are for the purpose of describing selected versions of the present invention and are not intended to limit the scope of the present invention.

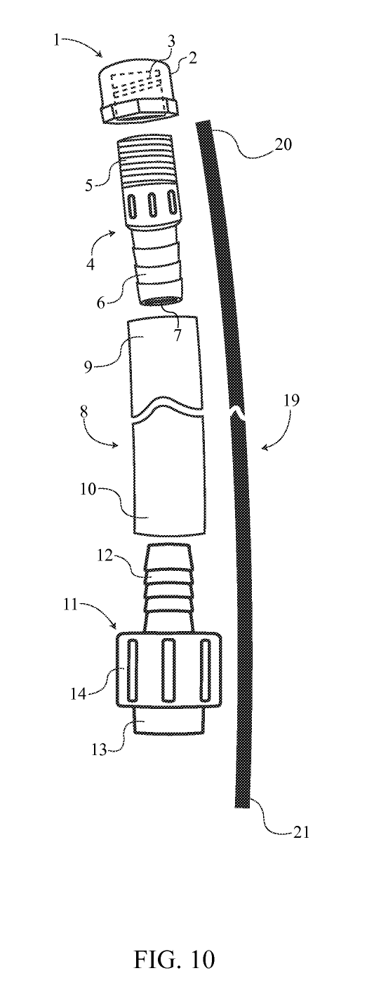

As can be seen in FIG. 10, the present invention is a venting spout-extending attachment, which attaches to pull-out spouts such as but not limited to Rieke spouts found on but not limited to pal lids, plastic containers, metal containers, etc. The present invention allows a user to pour out the fluid within a container in a controlled and steady manner while relieving the buildup of vacuum pressure within the container. The present invention is attached to a spout, which is typically located on the top of the container adjacent to lateral side of the container. The venting spout-extending attachment comprises a dust-cap 1, a dust-cap attachment 4, a transfer tube 8, a spout extender 11, and a vent tube 19. The spout extender 11 enables the present invention to attach to the spout of the container and allows the fluid to flow from the container into the present invention. The transfer tube 8 allows the user to direct the flow of the fluid out of the container. The transfer tube 8 has a first end 9 and a second end 10, which are positioned opposite to each other along the transfer tube 8. The vent tube 19 allows air to enter within the container in order to relieve the vacuum pressure that is created by the fluid being poured out of the container, which allows for a smooth and consistent outflow for the fluid. The vent tube 19 has an inside end 21 and an outside end 20, which are positioned opposite to each other along the vent tube 19. The dust-cap 1 is used to cover the end of the transfer tube 8 so that dust or other small particles cannot enter into the present invention and the container. The dust-cap attachment 4 allows the dust-cap 1 to be properly secured to transfer tube 8.

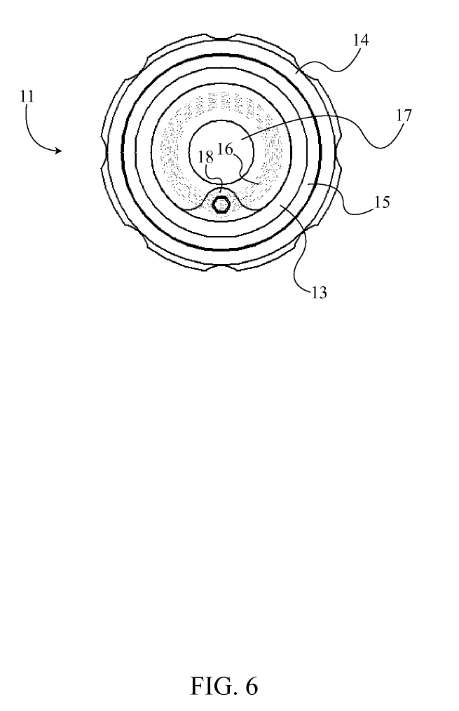

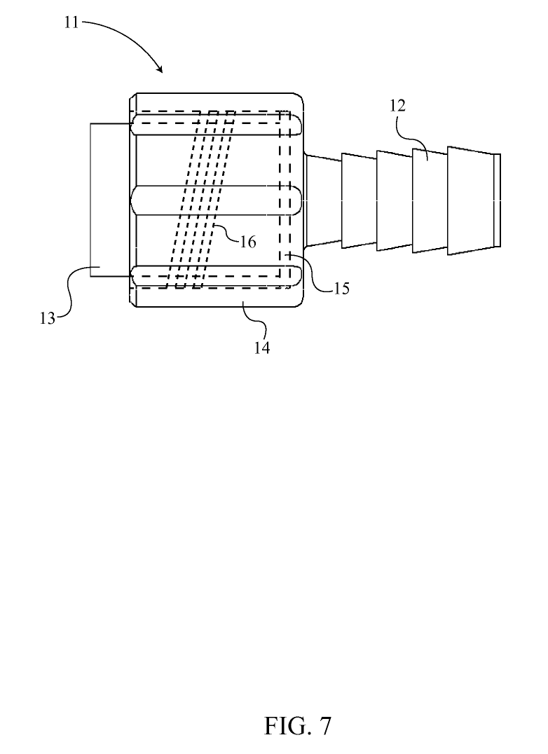

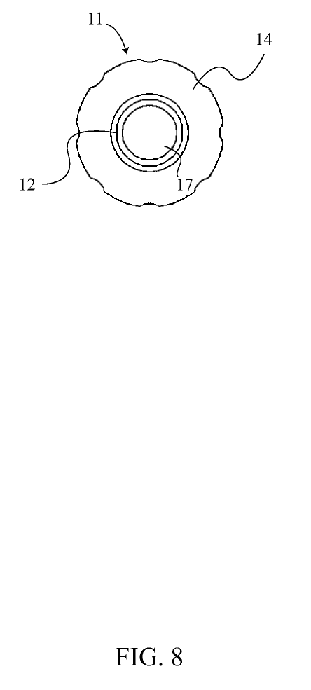

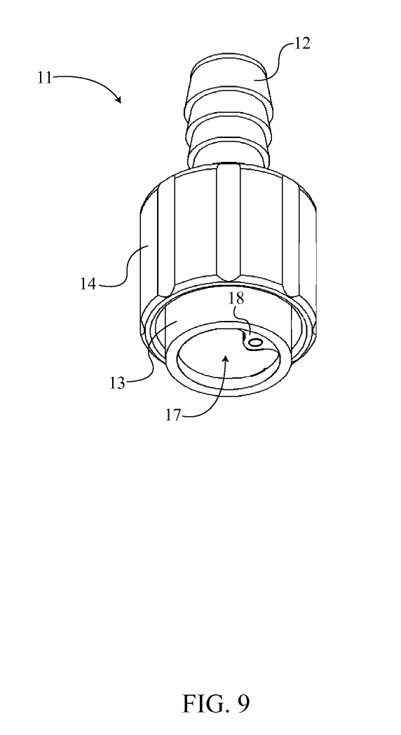

More specifically, the spout extender 11 is used to attach the transfer tube 8 to the spout of the container. In reference to FIGS. 6, 7, 8, and 9, the spout extender 11 comprises a ridged protrusion 12, an inner sleeve 13, an outer sleeve 14, a bearing 15, an interior thread 16, an extender passage 17, and a tube support 18. The ridged protrusion 12 is inserted into the second end 10 of the transfer tube 8, which creates a second hermetic seal between the transfer tube 8 and spout extender 11. The second hermetic seal is created by the ridges of the ridged protrusion 12 tightly pressing against the inner surface of the transfer tube 8. The ridged protrusion 12 is connected adjacent to the inner sleeve 13. The inner sleeve 13 is usually inserted into the spout of the container and is used to brace the spout extender 11 on the spout. The inner sleeve 13 fits inside of the spout of the container, which makes a spout ridge. The inner sleeve 13 is positioned collinearly to the ridged protrusion 12 so that no turbulence is created in the outflow of the fluid by the shape of the spout extender 11. The outer sleeve 14 is concentrically positioned around the inner sleeve 13 and is rotatably connected around the inner sleeve 13 by the bearing 15. The user can grasp the outer sleeve 14 in order to rotate the interior thread 16, which is used to lock the spout extender 11 on the spout. Both the bearing 15 and the interior thread 16 are positioned in between the inner sleeve 13 and the outer sleeve 14. The interior thread 16 is connected along the outer sleeve 14 so that the interior thread 16 will engage the threads of spout as the user rotates the outer sleeve 14. The interior thread 16 being engaged to the threads of spout will create a third hermetic seal between the spout extender 11 and the spout of the container. The bearing 15 is positioned adjacent to the ridged protrusion 12 so that the portion of spout being engaged by the interior thread 16 can traverse into the gap between inner sleeve 13 and the outer sleeve 14. The extender passage 17 is a hole that traverses through the inner sleeve 13 and through the ridged protrusion 12, which allows the outflow of fluid to travel through the spout extender 11. The tube support 18 is used to adequately brace the vent tube 19 as the vent tube 19 exits the spout extender 11. The tube support 18 is positioned within the extender passage 17 and is connected to the inner sleeve 13. The tube support 18 is also positioned opposite to the ridged protrusion 12 so that the tube support 18 can direct the vent tube 19 into the proper area within the container. Even though the drawings show a cylinder-shaped spout extender 11 with an inner sleeve 13, the spout extender 11 may comprise but is not limited to a square-shaped and an octagon-shaped device with an inner sleeve of any length and having any arrangement of vent tube support(s) 18. The spout extender 11 and the rest of the present invention may be made out of different materials including but not limited to metal, plastics, and composites.

More specifically, the dust-cap attachment 4 is attached to the transfer tube 8 opposite of the spout extender 11. The dust-cap attachment 4 is shown in FIG. 10 and comprises a threaded portion 5, a ridged portion 6, and an attachment passage 7. The ridged portion 6 is inserted in the first end 9 of the transfer tube 8, which creates a first hermetic seal between the dust-cap attachment 4 and the transfer tube 8. The first hermetic seal is created by the ridges of the ridged portion 6 tightly pressing against the inner surface of the transfer tube 8. The ridged portion 6 is connected adjacent to the threaded portion 5, which is used to attach the dust-cap 1. The threaded portion 5 is collinearly positioned to the ridged portion 6 so that no turbulence is created in the outflow of the fluid by the shape of the dust-cap attachment 4. The attachment passage 7 is a hole that traverses through the ridged portion 6 and through the threaded portion 5, which allows the outflow of fluid to travel through the dust-cap attachment 4. Furthermore, the dust-cap 1 is specifically attached to the dust-cap attachment 4 opposite to the transfer tube 8. The dust-cap 1 comprises an outer surface 2 and a threaded inner surface 3. The threaded inner surface 3 can be engaged by the threaded portion 5 of the dust-cap attachment 4, which allows the user to easily open up or close off the opening to the attachment passage 7, the transfer tube 8, and the extender passage 17. The outer surface 2 is concentrically located around the threaded inner surface 3 so that the user can easily grasp the dust-cap 1 and rotate the threaded inner surface 3 to engage to the threaded portion 5.

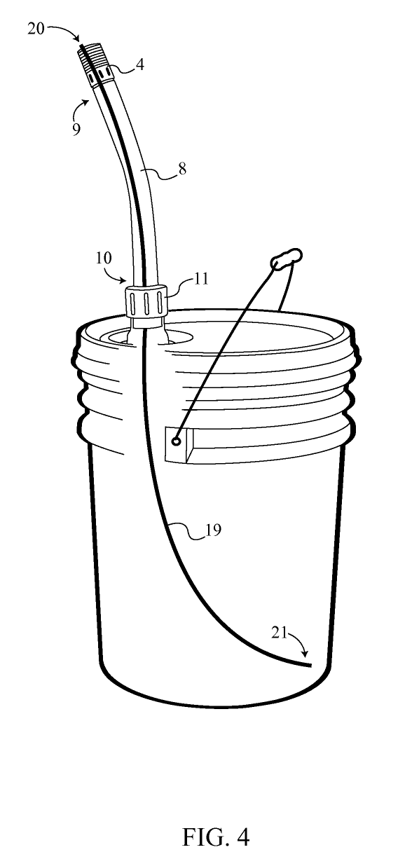

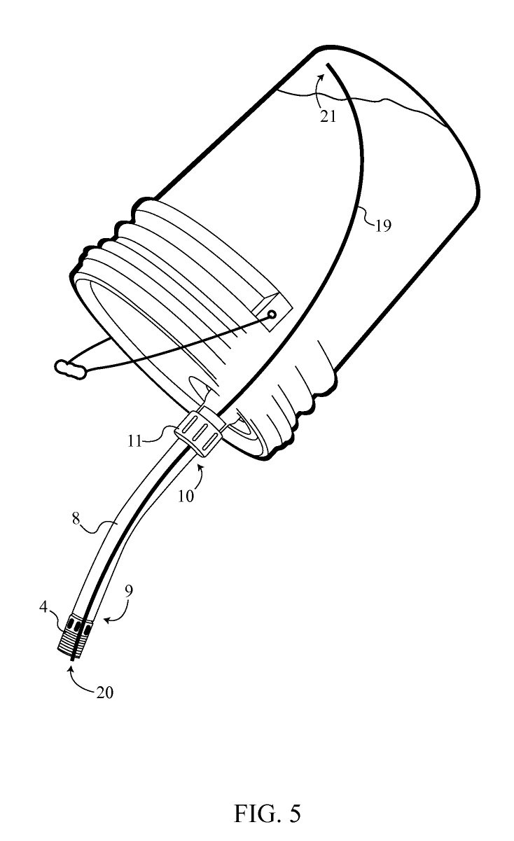

More specifically, the vent tube 19 traverses through the extender passage 17 of the spout extender 11, the transfer tube 8, and the attachment passage 7 of the dust-cap attachment 4. The vent tube 19 is also encircled by the tube support 18 in order to adequately brace the vent tube 19 within present invention and within the container. As can be seen in FIG. 4, the inside end 21 of the vent tube 19 traverses out of the inner sleeve 13 and into container. In reference to FIG. 5, the inside end 21 is typically positioned on the opposite side of the pull-out valve on a container because the side of the container with the pull-out valve will be tipped to pour out the fluid, which will create an air pocket on the opposite side of the container. The outside end 20 of the vent tube 19 traverses out of the threaded portion 5 of the dust-cap attachment 4. The outside end 20 protrudes out of the threaded portion 5 so that the outflow of the fluid does not block off the opening to the vent tube 19, which would prevent air from entering the container. In addition, the vent tube 19 traverses into and is covered by the dust-cap 1 when the dust-cap 1 is engaged to the dust-cap attachment 4.

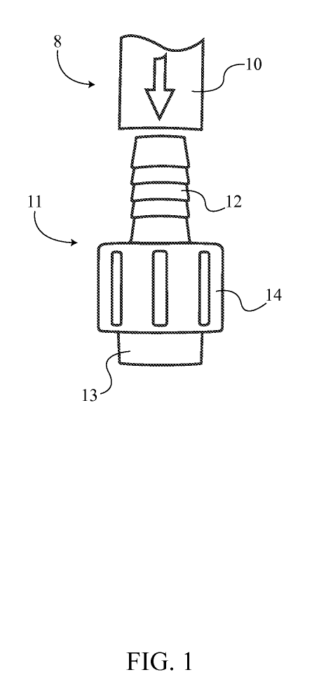

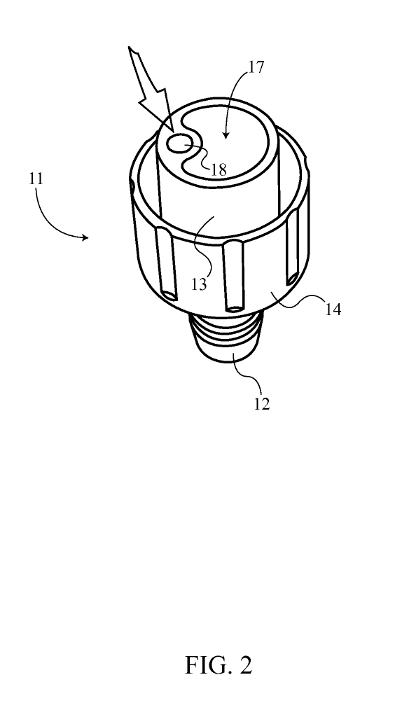

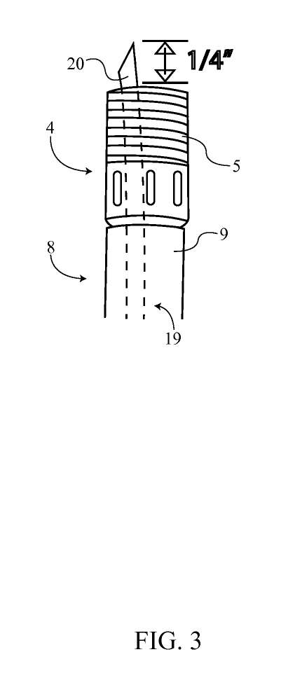

In the prototypically embodiment, the user assembles the present invention with the following method. First, the user should attach the second end 10 of the transfer tube 8 to the ridged protrusion 12 of the spout extender 11, which is shown in FIG. 1. The user should also attach the first end 9 of the transfer tube 8 to the ridged portion 6 of the dust-cap attachment 4. Second, the user should insert the vent tube 19 into tube support 18 of the spout extender 11, which is shown in FIG. 2, and should pull the vent tube 19 through the extender passage 17, the transfer tube 8, and the attachment passage 7. Once the vent tube 19 exits of the attachment passage 7, the user should adjust the vent tube 19 so that the outside end 20 protrudes out by one fourth of an inch as can be seen in FIG. 3. Third, the user should insert the vent tube 19 into the container through the pull-out spout and engage the interior thread 16 of the spout extender 11 to the threads of the pull-out spout, which is shown in FIG. 4. Once the vent tube 19 is positioned within the container, the inside end 21 of the vent tube 19 should sit at the bottom of the container on the opposite side of the pull-out spout. If the vent tube 19 is too long to sit at the bottom of the container on the opposite side of the pull-out spout, then the user should accordingly cut the vent tube 19. Finally, as the user begins to pour the fluid out of the container and through the present invention, the inside end 21 of the vent tube 19 will be located within the air pocket that is created by the outflow of the fluid, which is shown in FIG. 5.

In addition, the present invention is able to screw directly onto the pull out spout found on all plastic five gallon cans and on all metal five gallon cans. The present invention can also screw onto plastic lids. The present invention is designed to aid in the transfer of all fluids and make the transfer of fluids much easier. One aspect of the present invention that is very significant is that the vent tube allows air to flow into the bottom of the container, which releases the internal pressure and results in a quick smooth pour.

Although the invention has been explained in relation to its preferred embodiment, it is to be understood that many other possible modifications and variations can be made without departing from the spirit and scope of the invention as hereinafter claimed.

What is claimed is:

1. A venting spout-extending attachment comprises,
a dust-cap;
a dust-cap attachment;
a transfer tube;
a spout extender;
a vent tube;
said dust-cap comprises an outer surface and a threaded inner surface;
said dust-cap attachment comprises a threaded portion, a ridged portion, and an attachment passage;
said transfer tube comprises a first end and a second end;
said spout extender comprises a ridged protrusion, an inner sleeve, an outer sleeve, a bearing, an interior thread, an extender passage, and a tube support; and
said vent tube comprises an inside end and an outside end.

2. The venting spout-extending attachment as claimed in claim 1 comprises,
said spout extender being attached to said transfer tube;
said dust-cap attachment being attached to said transfer tube opposite of said spout extender;
said dust-cap being attached to said dust-cap attachment opposite of said transfer tube; and
said vent tube traversing through said spout extender, said transfer tube, and said dust-cap attachment.

3. The venting spout-extending attachment as claimed in claim 1 comprises,
said inner sleeve being collinearly positioned to said ridged protrusion;
said inner sleeve being connected adjacent to said ridged protrusion;
said outer sleeve being concentrically positioned around said inner sleeve;
said bearing being concentrically positioned in between said outer sleeve and said inner sleeve adjacent to said ridged protrusion;
said outer sleeve being rotatably connected to said inner sleeve by said bearing;
said interior thread being positioned in between said outer sleeve and said inner sleeve;
said interior thread being connected along said outer sleeve;
said extender passage being traversing through said inner sleeve and said ridged protrusion;
said tube support being positioned within said extender passage; and
said tube support being connected to said inner sleeve opposite to said ridged protrusion.

4. The venting spout-extending attachment as claimed in claim 1 comprises,
said ridged portion being collinearly positioned to said threaded portion;
said ridged portion being connected adjacent to said threaded portion; and
said attachment passage traversing through said threaded portion and said ridged portion.

5. The venting spout-extending attachment as claimed in claim 1 comprises,
said first end and said second end being positioned opposite of each other along said transfer tube.

6. The venting spout-extending attachment as claimed in claim 5 comprises,
said ridged portion being inserted into said first end; and
said ridged protrusion being inserted into said second end.

7. The venting spout-extending attachment as claimed in claim 1 comprises,
said outer surface being concentrically located around said threaded inner surface.

8. The venting spout-extending attachment as claimed in claim 7 comprises,
said threaded inner surface being engaged by said threaded portion.

9. The venting spout-extending attachment as claimed in claim 1 comprises,
said vent tube being encircled by said tube support;
said vent tube traversing through said extender passage; and
said vent tube traversing through said attachment passage.

10. The venting spout-extending attachment as claimed in claim 9 comprises,
said inside end and said outside end being positioned opposite of each other along said vent tube;
said inside end traversing out of said inner sleeve; and
said outside end traversing out of said threaded portion.

11. A venting spout-extending attachment comprises,
a dust-cap;
a dust-cap attachment;
a transfer tube;
a spout extender;
a vent tube;
said dust-cap comprises an outer surface and a threaded inner surface;
said dust-cap attachment comprises a threaded portion, a ridged portion, and an attachment passage;
said transfer tube comprises a first end and a second end;
said spout extender comprises a ridged protrusion, an inner sleeve, an outer sleeve, a bearing, an interior thread, an extender passage, and a tube support;
said vent tube comprises an inside end and an outside end;
said spout extender being attached to said transfer tube;
said dust-cap attachment being attached to said transfer tube opposite of said spout extender;
said dust-cap being attached to said dust-cap attachment opposite of said transfer tube;
said vent tube traversing through said spout extender, said transfer tube, and said dust-cap attachment;
said inner sleeve being collinearly positioned to said ridged protrusion;
said inner sleeve being connected adjacent to said ridged protrusion;
said outer sleeve being concentrically positioned around said inner sleeve;
said bearing being concentrically positioned in between said outer sleeve and said inner sleeve adjacent to said ridged protrusion;
said outer sleeve being rotatably connected to said inner sleeve by said bearing;
said interior thread being positioned in between said outer sleeve and said inner sleeve;
said interior thread being connected along said outer sleeve;
said extender passage being traversing through said inner sleeve and said ridged protrusion;
said tube support being positioned within said extender passage; and
said tube support being connected to said inner sleeve opposite to said ridged protrusion.

12. The venting spout-extending attachment as claimed in claim 11 comprises,
said ridged portion being collinearly positioned to said threaded portion;
said ridged portion being connected adjacent to said threaded portion; and
said attachment passage traversing through said threaded portion and said ridged portion.

13. The venting spout-extending attachment as claimed in claim 11 comprises,
said first end and said second end being positioned opposite of each other along said transfer tube;
said ridged portion being inserted into said first end; and
said ridged protrusion being inserted into said second end.

14. The venting spout-extending attachment as claimed in claim 11 comprises,
said outer surface being concentrically located around said threaded inner surface; and
said threaded inner surface being engaged by said threaded portion.

15. The venting spout-extending attachment as claimed in claim 11 comprises,
said vent tube being encircled by said tube support;
said vent tube traversing through said extender passage;
said vent tube traversing through said attachment passage;
said inside end and said outside end being positioned opposite of each other along said vent tube;
said inside end traversing out of said inner sleeve; and
said outside end traversing out of said threaded portion.

16. A venting spout-extending attachment comprises,
a dust-cap;
a dust-cap attachment;
a transfer tube;
a spout extender;
a vent tube;
said dust-cap comprises an outer surface and a threaded inner surface;
said dust-cap attachment comprises a threaded portion, a ridged portion, and an attachment passage;
said transfer tube comprises a first end and a second end;
said spout extender comprises a ridged protrusion, an inner sleeve, an outer sleeve, a bearing, an interior thread, an extender passage, and a tube support;
said vent tube comprises an inside end and an outside end;
said spout extender being attached to said transfer tube;
said dust-cap attachment being attached to said transfer tube opposite of said spout extender;
said dust-cap being attached to said dust-cap attachment opposite of said transfer tube;
said vent tube traversing through said spout extender, said transfer tube, and said dust-cap attachment;
said inner sleeve being collinearly positioned to said ridged protrusion;
said inner sleeve being connected adjacent to said ridged protrusion;
said outer sleeve being concentrically positioned around said inner sleeve;
said bearing being concentrically positioned in between said outer sleeve and said inner sleeve adjacent to said ridged protrusion;
said outer sleeve being rotatably connected to said inner sleeve by said bearing;
said interior thread being positioned in between said outer sleeve and said inner sleeve;
said interior thread being connected along said outer sleeve;
said extender passage being traversing through said inner sleeve and said ridged protrusion;
said tube support being positioned within said extender passage;
said tube support being connected to said inner sleeve opposite to said ridged protrusion;
said vent tube being encircled by said tube support;
said vent tube traversing through said extender passage;
said vent tube traversing through said attachment passage;
said inside end and said outside end being positioned opposite of each other along said vent tube;
said inside end traversing out of said inner sleeve; and
said outside end traversing out of said threaded portion.

17. The venting spout-extending attachment as claimed in claim 16 comprises,
said first end and said second end being positioned opposite of each other along said transfer tube;
said ridged portion being inserted into said first end; and
said ridged protrusion being inserted into said second end.

18. The venting spout-extending attachment as claimed in claim 16 comprises,
said ridged portion being collinearly positioned to said threaded portion;
said ridged portion being connected adjacent to said threaded portion;
said attachment passage traversing through said threaded portion and said ridged portion;
said outer surface being concentrically located around said threaded inner surface; and
said threaded inner surface being engaged by said threaded portion.
